(19) United States
(12) Patent Application Publication
(10) Pub. No.: US 2009/0193817 A1
(43) Pub. Date: Aug. 6, 2009

(54) METHOD FOR REFRIGERATING A THERMAL LOAD

(75) Inventors: Jean-Pierre Germain, Montigny-Le-Bretonneux (FR); Didier Alo, Savigny Sur Orge (FR); Jean-Yves Thonnelier, Voisins Le Bretonneux (FR)

Correspondence Address: AIR LIQUIDE;Intellectual Property, 2700 POST OAK BOULEVARD, SUITE 1800, HOUSTON, TX, 77056, US

(73) Assignee: L'AIR LIQUIDE SOCIETE ANONYME A DIRECTOIRE ET CONS, Paris (FR)

(21) Appl. No.: 11/915,934

(22) PCT Filed: May 18, 2006
(86) PCT No.: PCT/FR06/50460

§ 371 Date: Dec. 5, 2008

(30) Foreign Application Priority Data
Jun. 2, 2005 (FR) 0551475

(51) Int. Cl. F25B 19/00; F25D 25/00; C09K 5/00; F25B 1/00

(52) U.S. Cl. 62/51.1; 62/62; 62/114; 62/115

(57) ABSTRACT

The invention concerns a method for refrigerating one or more thermal loads which consists in providing a first CO2 source derived from a mechanical cold system, and in feeding one or more evaporators from said first source so as to cause the CO2 to evaporate thereby cooling said one or more thermal loads. The method is characterized in that it consists in providing a second CO2 source, consisting of a cryogenic storage of CO2, and in inputting CO2 from said second source, so that the flow rate of fluid feeding the evaporator(s) is a mixture of liquid CO2 derived from said first source and liquid CO2 derived from said second source.

The present invention relates to the field of refrigeration, particularly of the mechanical type and the cryogenic type, and is concerned in particular with applications in the field of the treatment of food products, such as deep freezing and freezing.

For a very long time, mechanical refrigeration systems have used ammonia (NH₃) or HCFC (hydrochlorofluorocarbons) or HFC (hydrofluorocarbons) as refrigerants.

However, evolving environmental legislation has penalized the use of these fluids, either for safety considerations, particularly for ammonia; or for environmental considerations, as is the case for HCFCs and CFCs.

Manufacturers of refrigeration systems are therefore seeking other refrigerants more compliant with the legislation, and have accordingly focused their attention on “natural” fluids, such as carbon dioxide, air, water, etc.

Their choice has fallen in particular on an NH₃+CO₂ combination associated with a cascade cycle, for obtaining refrigeration capacity at evaporation temperatures preferably of between −20 and −55° C.

CO₂ can also be employed as a two-phase refrigerant in association with a compression cycle using a refrigerant such as ammonia.

The new generations of cascade system comprise two distinct compression units:
the high pressure circuit using as refrigerant ammonia or any other refrigerant suitable for being cooled by the ambient medium or a cold source (temperature between 10 and 30° C.) and
the low pressure circuit using carbon dioxide to feed the evaporator producing the useful refrigeration.

As a reminder, it is known that the expression “mechanical refrigeration” system generally means a refrigeration system using a condensable vapor compression cycle, and “cryogenic refrigeration” system generally means a system producing refrigeration brought about by a change of phase of a cryogenic fluid in an open circuit.

For the chilling, crust-freezing or freezing of food products, two types of technology are commonly employed:
“cryogenic” refrigeration uses the refrigeration produced by the phase change of a cryogenic fluid, for example the sublimation of carbon dioxide or the vaporization of liquid nitrogen. This technology operates in an open circuit, that is, with disposable fluids. The capital investment is thereby minimized;
“mechanical” refrigeration uses the refrigeration produced by the expansion of a refrigerant, for example carbon dioxide. This technology operates in a closed circuit with a constant fluid load. The capital investment is higher because compressors must be provided.

It is clear that the ability to switch from a mechanical refrigeration system to a cryogenic system, and vice versa, or to combine the two systems, would afford the user greater flexibility.

Thus for example, manufacturers who have opted for a mechanical refrigeration system could, during a given period, use the deep freezer with a cryogenic cold source, which would in particular have the advantage of improving the spreading of the investments during the period of launching of the frozen product on the market.

In fact, the capital investment for a deep freezing unit with mechanical refrigeration is broken down into two substantially equivalent parts, between the deep freezer and the refrigeration installation. It could be advantageous for the manufacturers to minimize their investments by replacing the refrigeration production by cryogenic storage, only making the refrigeration investment when the refrigeration requirements for production no longer enable the cryogenic system to be competitive, which also has the advantage of minimizing the financial risks during the product launch period.

Furthermore, every mechanical system requires periods of shutdown for maintenance. It is commonly accepted to shut down the refrigeration system (i.e. the compressors) and the refrigeration installation (the deep freezer) for about four weeks per year for maintenance of the compressors and the various components of the deep freezer. During this maintenance period, the installation no longer produces. The ability to operate temporarily using a cryogenic fluid would have the advantage of:
enabling continuous production without the shutdowns due to maintenance periods,
providing backup refrigeration during breakdowns.

In conclusion, the simultaneous operation of mechanical refrigeration and cryogenic refrigeration could serve to increase refrigeration capacity during peak periods.

Solutions have already been proposed in the literature to deal with a shutdown of the compression circuit or to increase refrigeration production or to optimize performance, and these solutions call for the addition of:
a heat exchanger between an external fluid cooling the internal fluid of the mechanical refrigeration circuit, this heat exchanger being placed between the evaporator and the compressor, or being introduced into the low pressure cylinder (see for illustration document U.S. Pat. No. 5,331,824A).
a bar for spraying cryogenic fluid on the product, or in the cooling battery (see for example document U.S. Pat. No. 5,410,886) or in the cooling space (see for example document EP-0652409), or the installation of a cryogenic bath (see for example documents U.S. Pat. No. 5,220,803, EP-0360224, EP-0361700).
An additional heat exchanger so that the cryogenic fluid is evaporated in a circuit independent of the circuit of the mechanical system (see for example document U.S. Pat. No. 5,996,355).
An independent device for cooling the products, either at the inlet or the outlet of the main refrigeration unit using the mechanical cold source (see for example document U.S. Pat. No. 5,220,803).
Another alternative considered is to combine cryogenic refrigeration with mechanical refrigeration to improve the performance of both systems (see for example documents U.S. Pat. No. 6,425,264B1, US2002/0124587, U.S. Pat. No. 5,694,776, EP-0208526, U.S. Pat. No. 5,343,715).

Thus, combined refrigeration using cryogenic and mechanical systems has been designed:
to exploit the advantage of the two technologies: rapid cooling by cryogenic cold source and low operating cost of the mechanical cold source;
as a booster: the cryogenic cold source increases the refrigeration capacity of the mechanical system; and
to recover the cold cryogenic fluid vapors.

Combined refrigeration makes use of both technologies. The final “desired” refrigeration action may be due to mechanical refrigeration and cryogenic refrigeration or due to only one of the two systems. The system which does not directly contribute to the “desired” refrigeration action is used to enable the other system to operate under extended conditions (power, temperature).

It should be noted that in all known cases of combination of mechanical and cryogenic refrigeration, the fluids of the two systems are not mixed. The two systems remain completely independent and parallel, at best a slight “coupling” is obtained by recovering the cold cryogenic fluid vapors to send them to the heat exchanger of the mechanical refrigeration system and thereby recover some refrigeration capacity (in the opposite case, these cold vapors are simply discharged to the surrounding atmosphere).

As shown in greater detail below, it is the object of the present invention to propose a device in which, on the contrary, the “consumable” cryogenic fluid is CO₂ and is mixed with the fluid of the mechanical system which feeds the evaporator of the installation using the cold source to cool a thermal load. The latter fluid is also CO₂, both for the “recycled” refrigerant and the refrigerating fluid. This additional CO₂ injection takes place before producing refrigeration in the evaporator.

The fluid of the mechanical refrigeration circuit having to remain at constant weight, it is necessary for the quantity of original cryogenic CO₂ injected to be removed from the network after having been vaporized. As shown below, this extraction of CO₂ vapor can be carried out at various locations of the circuit.

According to the present invention, the proposed solution consists in mixing the fluids issuing from an open circuit using CO₂ as cryogenic fluid and from a closed circuit using CO₂ as a refrigerant or as a refrigerating fluid.

More precisely, the present invention relates to a method for refrigerating one or more thermal loads whereby a first CO₂ source is provided from a mechanical refrigeration system, and in which one or more evaporators is fed from said first source to cause the evaporation of the CO₂ and thereby cool said one or more thermal loads, and is characterized in that a second CO₂ source, consisting of a cryogenic CO₂ storage unit, is provided and in that there is an influx of CO₂ from said second source, so that the flow of fluid fed to the evaporator(s) is a mixture of liquid CO₂ issuing from said first source and liquid CO₂ issuing from said second source.

Method for refrigerating one or more thermal loads whereby a first CO₂ source is provided from a mechanical refrigeration system, and in which one or more evaporators is fed from said first source to cause the evaporation of the CO₂ and thereby cool said one or more thermal loads,

characterized in that a second CO₂ source, consisting of a cryogenic CO₂ storage unit, is provided and in that there is an influx of CO₂ from said second source, so that the flow of fluid fed to the evaporator(s) is a mixture of liquid CO₂ issuing from said first source and liquid CO₂ issuing from said second source.

According to one of the embodiments of the invention, the mechanical refrigeration system carries out the steps of:
compression of CO₂ in the vapor state;
condensation of the CO₂ thus compressed in a heat exchanger;
expansion of the CO₂ thus subcooled;
storage of the CO₂ thus expanded in a storage tank; and the following measures are carried out:
CO₂ is extracted from the storage tank to feed said one or more evaporators;
a quantity of CO₂ substantially equivalent to that corresponding to said influx of CO₂ is removed to the exterior by one or a combination of the following methods:
i) the fluid or part of the fluid obtained at the outlet of the evaporator(s) is sent to said storage tank and said CO₂ stream to be removed to the exterior is extracted and removed from said tank;
j) part of the fluid obtained at the outlet of the evaporator(s) is separated and removed to the exterior, the remainder being sent either to said storage tank, or to said compression step; and
said influx of CO₂ from said second source is carried out in said storage tank where it is mixed with the CO₂ issuing from said evaporator(s) or from said expansion step.

According to another of the embodiments of the invention, a quantity of CO₂ substantially equivalent to that corresponding to said influx of CO₂ is removed to the exterior by one or a combination of the following methods:

i) the fluid or part of the fluid obtained at the outlet of the evaporator(s) is sent to a storage tank and said CO₂ stream to be removed to the exterior is extracted and removed from said tank;

j) part of the fluid obtained at the outlet of the evaporator(s) is separated and removed to the exterior, the remainder being sent either to said storage tank, or to a step of condensation by a cold source provided by a vapor compression system and the liquid thereby condensed is then stored in the storage tank;

and said influx of CO₂ from said second source is carried out in the storage tank where it is mixed with the CO₂ issuing from the evaporator(s) or from said condensation step.

Advantageously, the quantity of CO₂ present in the circuit is comprised between two predefined operating limits.

As it clearly appears from a reading of the above, it is therefore possible thereby to maintain production, by ensuring the continuity of refrigerating capacity, by an injection, into the CO₂ circuit issuing from the mechanical system, of an influx of liquid CO₂ issuing from a storage unit which is connected to the “mechanical” CO₂ distribution network, an equivalent quantity (or in any case substantially equivalent) to that of the original cryogenic CO₂ injected into the circuit being subsequently discharged, for example after the evaporation of the fluid in the evaporator of the installation for cooling the thermal load concerned (for example a deep freezer).

As shown below, the important factor is to ensure that the quantity of CO₂ present in the circuit does not increase endlessly in an uncontrolled manner (due to the influx of original cryogenic CO₂), which would be inconceivable, quite on the contrary the quantity of CO₂ present in the circuit remains substantially constant or in any case remains comprised between two acceptable and predefined operating limits. A quantity of CO₂ substantially equivalent to that which has been admitted into the circuit and which was of cryogenic origin must therefore be removed to the exterior of the circuit.

According to the present invention, one or the other of the following combined solutions can thus be adopted:
all the fluid obtained at the outlet of the evaporator(s) (of the installation using refrigeration to cool a thermal load) can be sent to a noncryogenic storage tank (from which tank the evaporators are fed), and this tank is used for the extraction and the flow to be removed to the exterior;
it is also possible, at the outlet of the evaporator(s) to proceed directly with the separation of part of the flow issuing from the evaporator(s) to remove it, the remainder being sent either to the noncryogenic storage tank, or to the mechanical refrigeration cycle (compression step or condensation step).

Thus, in short, the useful refrigeration is produced by the evaporation of a stream of CO₂ issuing from the mixture of a flow from a cryogenic CO₂ storage unit and a flow of CO₂ obtained by a mechanical system.

The “total” CO₂ flow produces the useful refrigeration in an evaporator located in the installation using the refrigeration to cool a load.

As stated above, after evaporation, the total CO₂ flow is separated into two streams, one substantially equal to the flow from the cryogenic storage unit, and the other equal to the flow originating from the mechanical refrigeration.

Preferably, the flow of mixed cryogenic CO₂ and the flow of separated CO₂ are controlled respectively by opening a feed valve from the storage unit and by opening the CO₂ extraction valve. These valves are controlled for example:
by the measurement of the liquid CO₂ level in the tank feeding the evaporator;
by the CO₂ evaporation pressure or temperature.

The flow which substantially corresponds to the one from the cryogenic storage unit is removed directly to the atmosphere or indirectly by passing through an oil separation phase if necessary.

The flow which corresponds to that from the mechanical refrigeration is recondensed by the mechanical system.

The coupling of the two circuits can be achieved in various ways, and particularly:

1. In the Case in which the CO₂ from the Mechanical System is the Refrigerant:

The two CO₂ streams can be mixed:
in the circuit upstream of the evaporator at the evaporation pressure, for example in the low pressure cylinder containing the liquid CO₂ produced by mechanical refrigeration,
in the circuit upstream of the pressure-reducing valve of the mechanical system, between the condenser and the pressure-reducing valve.

After evaporation in the evaporator, the two streams can be separated:
in the circuit just after the evaporator;
in the low pressure cylinder from which the CO₂ vapors are recompressed by the compressor of the mechanical refrigeration system.
   2. In the Case in which the CO₂ is the Refrigerating Fluid of the Mechanical System

The two CO₂ streams can be mixed:
in the storage cylinder of the refrigerating CO₂ which is at the evaporation pressure;
between the evaporator and the low pressure CO₂ storage cylinder.

After evaporation in the evaporator, the two streams can be separated:
in the circuit just after the evaporator;
in the low pressure cylinder in which the CO₂ recondensed by mechanical refrigeration has accumulated.

As stated above, the coupling of the two circuits must be controlled so that the quantity of CO₂ present in the closed circuit remains substantially constant or remains at least comprised between two acceptable operating limits.

The flow of mixed cryogenic CO₂ and the flow of separated CO₂ are controlled respectively, for example, by opening a feed valve from the storage unit and by opening the CO₂ extraction valve. These valves can be controlled for example either:
by the measurement of the liquid CO₂ level in the tank feeding the evaporator; or
by the CO₂ evaporation pressure or temperature.

Other features and advantages of the invention will appear from the examples described in detail below.

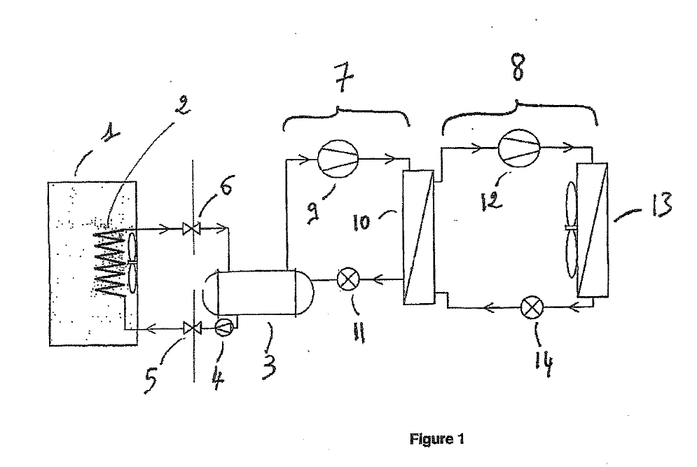

FIG. 1 is a schematic representation of an exemplary mechanical refrigeration system (two compression units);

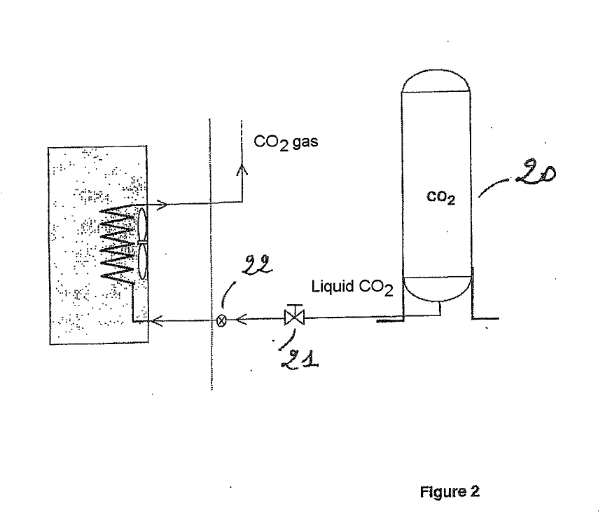

FIG. 2 is a schematic representation of a cryogenic refrigeration system;

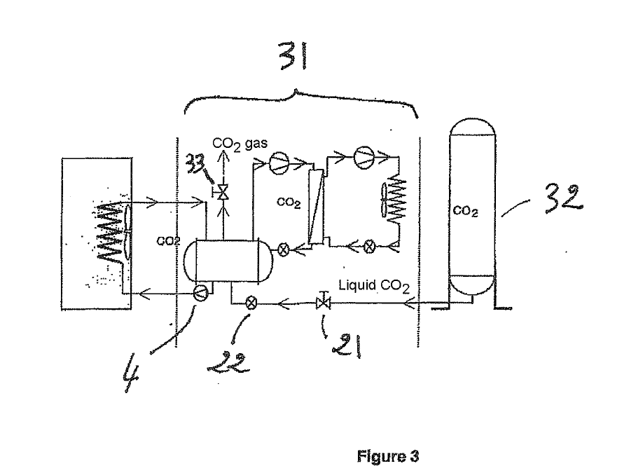

FIG. 3 is a schematic representation of an installation suitable for implementing the invention;

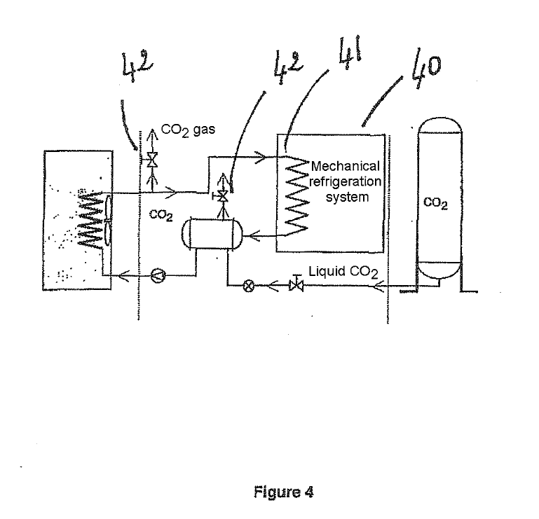

FIG. 4 is a schematic representation of a second installation suitable for implementing the invention (mixing of the fluids issuing from the open circuit using CO₂ as cryogenic fluid and the closed circuit also using CO₂ as refrigerating fluid);

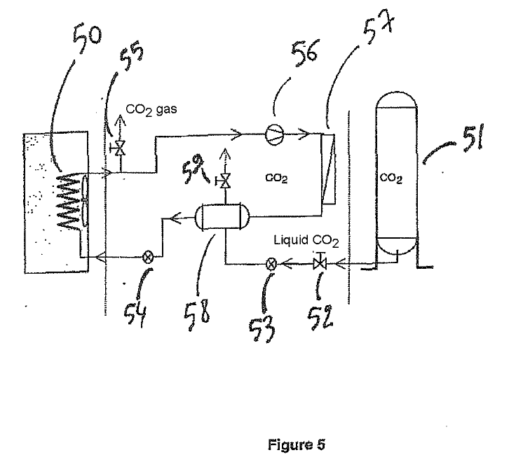

FIG. 5 is a schematic representation of a third installation suitable for implementing the invention; and

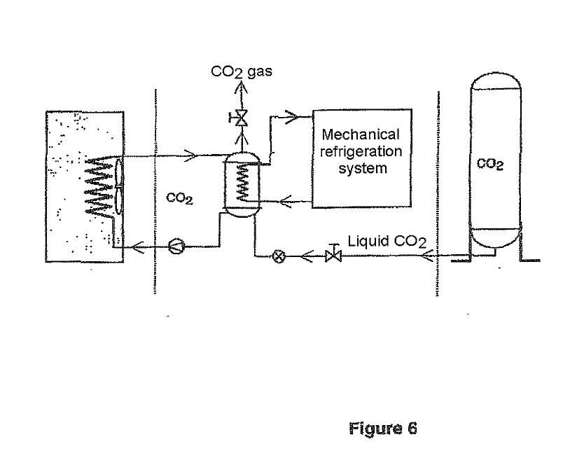

FIG. 6 is a schematic representation of a fourth installation suitable for implementing the invention.

FIG. 1 shows the following elements:
by numeral 1: a thermal load, for example a deep freezer; the thermal load may be distributed over several uses, each comprising an evaporator (2) where the CO₂ produces a refrigerating effect by evaporation;
at 2: the heat exchanger/CO₂ evaporator delivering the refrigeration to the thermal load by evaporation of the CO₂ and via an intermediate fluid (generally air), evaporation of the CO₂ typically takes place between 5.2 bar and 26.5 bar and preferably between 5.5 bar and 10 bar;
at 3: a liquid CO₂ storage tank; its operating pressure is that of the CO₂ evaporator, to within the pressure drop;
at 4: a CO₂ circulating pump for supplying the evaporator(s);
at 5 and 6: short-circuit valves;
at 7: a low temperature vapor compression system using CO₂ as refrigerant (the CO₂ vapors are compressed by the compressor 9 and are then condensed in an evaporator-condenser heat exchanger 10, at a temperature of typically between −20° C. and −10° C. preferably. The liquid obtained undergoes a pressure drop in a pressure-reducing member 11 where a fraction of CO₂ is vaporized, enabling the cooling of the CO₂ stream between −56° C. and −10° C. The CO₂ obtained is stored in the tank 3 at the circuit low pressure;
at 8: a high temperature vapor compression system using a refrigerant such as ammonia (NH₃), or the HFCs R404, R410, or any other fluid suitable for condensing the CO₂ by vaporizing (preferably between −30° C. and −5° C.) and condensing at the circuit high pressure preferably between 15° C. and 45° C.;
at 9: a compressor tapping off the CO₂ vapors from the tank 3 to compress them to the condensation high pressure;
at 10: a heat exchanger for condensing the CO₂ by heat transfer to the high temperature circuit (the CO₂ condensing preferably between −28° C. and −10° C.);
at 11: a member for reducing the pressure between the high pressure and the low pressure of the CO₂ low temperature circuit;
at 12: a compressor of the refrigerant vapors from the high temperature circuit.
at 13: a heat exchanger for condensing the refrigerant of the high temperature circuit with ambient air or another cold source (for example a cold water network); the fluid is typically condensed preferably between 15° C. and 45° C.; and
at 14: a member for reducing the pressure between the high pressure and the low pressure of the high temperature circuit.

It is accordingly known that the thermal load to be cooled (1) is cooled by a vapor compression cycle cascaded at low temperature with CO₂ as refrigerant. The advantage of a cascade is to obtain a high energy efficiency when the total temperature difference between the low temperature evaporator and the high temperature condenser is high. The CO₂ evaporation temperature is adjusted for the use of the cooling required between −56° C. and −10° C.

The heat exchange between the CO₂ condenser and the evaporation of the high pressure circuit takes place at an optimized temperature depending on the refrigerant of the high temperature circuit and the total temperature difference, and is generally between −28° C. and −5° C.

The CO₂ in the low temperature circuit flows in a closed circuit.

FIG. 2 shows the following elements:
by numeral 20: a cryogenic CO₂ storage tank at a pressure typically and preferably between 15 and 30 bar;
at 21: a liquid CO₂ flow control valve; and

at 22: a pressure-reducing member causing the CO₂ to go from the storage pressure to the operating pressure in the evaporator, i.e. typically between 5.2 bar and 26.5 bar and preferably between 5.5 bar and 10 bar.

The CO₂ tank serves to feed one or more evaporators for cooling the thermal load or loads. The flow(s) are controlled according to a temperature or a pressure. The CO₂ evaporates in one or more evaporators between −56° C. and −10° C. The vaporized CO₂ is discharged to the atmosphere via an exhaust duct.

FIG. 3 is a schematic representation of one of the embodiments of the present invention.

The thermal load or loads are cooled by the evaporation of the CO₂ in one or more evaporators 2. The liquid CO₂ fed to the evaporator(s) is supplied with a cascaded vapor compression system 31 comparable to the one described in connection with FIG. 1, and with a cryogenic CO₂ storage unit 32. The two liquid CO₂ supply means are connected in the storage tank 3 of the low temperature circuit of the cascaded system where the two CO₂ streams are mixed.

The CO₂ issuing from the condensation of the low temperature circuit is expanded in the member 11 and accumulates in the tank 3.

The CO₂ from the cryogenic storage unit is flow-controlled by the valve 21 and is expanded by the member 22 to the pressure of the tank 3.

The circulating pump 4 serves to feed the evaporator(s) cooling the thermal load(s). The pump must be dimensioned to circulate a flow equal to the sum of the CO₂ streams supplied by the cryogenic storage unit 32 and the low pressure compression circuit 7. The same applies to the evaporator(s) 2 which are dimensioned using the sum of the CO₂ streams.

When the compression system reaches its liquefied CO₂ flow limits and the refrigerating capacity thereby produced by the evaporation of the CO₂ thus produced is not sufficient to cool the thermal load, the additional refrigerating capacity is supplied by the CO₂ stream from the cryogenic storage unit 32. The quantity of CO₂ injected into the tank 3 must be removed after evaporation of the liquid via an extraction circuit 33.

The CO₂ flow supplied by the storage unit 32 can provide from 0 to 100% of the refrigerating capacity associated with the thermal load(s). Preferably, the CO₂ from the storage unit serves to supplement the refrigerating capacity of the compression system during production peaks in order to avoid oversizing said compression system. During shutdowns of the compression system, for maintenance or breakdown, the CO₂ from the cryogenic storage unit can supply 100% of the refrigerating needs, thereby avoiding the shutdown of production.

The operating pressures and temperatures of the cascaded compression system and of the cryogenic storage unit are, for example, comparable to those already indicated with reference to FIGS. 1 and 2 above.

FIG. 4 shows another exemplary embodiment of the invention.

The thermal load or loads are cooled by one or more evaporators 2 using CO₂. The liquid CO₂ is supplied, on the one hand, by the liquefaction of all or part of the CO₂ vapors issuing from the evaporator(s) 2, condensation carried out in the heat exchanger 41, and on the other, by the CO₂ issuing from the cryogenic storage unit. The CO₂ flowing through the evaporator(s) and the condenser 41 is called the “refrigerating” fluid.

A refrigeration system 40 (compression system using CO₂ or other refrigerants in a cascade or not) serves for liquefying the CO₂ from one or more evaporators 2. The liquefaction of the CO₂ can take place in a heat exchanger distinct from the storage tank 3 (as is the case in this FIG. 4) or in this tank via a heat exchanger (as is the case in connection with FIG. 6).

The use of a refrigerating circuit serves to split the compression system, which may be installed in a technical room separate from the installation cooling the thermal load.

The operation of the coupling of the refrigerating CO₂ circuit and the CO₂ from the cryogenic storage unit is similar to that of FIG. 3. A reserve 3 allows the mixing of the two CO₂ streams and two extraction lines 42 serve to extract a quantity of CO₂ equal to that issuing from the cryogenic storage unit and to remove it to the external ambient air. This extraction is carried out downstream of the evaporator 2 (on the line returning to the tank 3) and/or directly on the tank 3. The latter case forces the condenser 41 to avoid completely condensing the CO₂ stream.

The typical operating pressures and temperatures of such an installation for operating the evaporator 2 are comparable to those described in relation to FIGS. 1 and 2.

In connection with FIG. 5, the compression system producing the refrigerating action for completely or partially cooling the thermal load consists of the compressor 56, a condenser 57, and a high pressure tank 58, a pressure-reducing member 54 and one (or more) evaporator(s) 50. The refrigerant is CO₂.

The cryogenic storage unit of CO₂ 51 is connected to the storage tank 58 via a line equipped with a flow control valve 32 and a pressure-reducing member 53. The CO₂ is mixed with that of the compression system in the tank 58.

The system operates in the modes described above, the CO₂ from the cryogenic storage unit providing from 0 to 100% of the refrigerating needs, but is preferably used to supplement the refrigerating capacity of the compression system during production peaks or the shutdown thereof.

The CO₂ from the cryogenic storage unit is partially vaporized by expansion in the member 53. The vapor is removed from the tank 58 by an extraction line 59. The liquid CO₂ accumulated in the tank 58 is expanded in the pressure-reducing member 54 and is evaporated in the evaporator 50. Between the evaporator and the compressor 56, a CO₂ vapor extraction unit (55) is installed to discharge the CO₂ introduced by the cryogenic storage unit. The extractions 55 and 59 are adjusted so that the quantity of CO₂ extracted is equal to the quantity of CO₂ introduced by the cryogenic storage unit.

The condenser 57 is cooled by a compression system forming a cascade as explained for FIG. 3 and not described again here.

As may be seen, one of the main differences between the embodiment in FIG. 3 and that in FIG. 5 resides in the position of the CO₂ storage tank, which may be at low pressure (FIG. 3) or at high pressure (FIG. 5) of the CO₂ compression system. If the device in FIG. 3 is advantageous for simplifying the control of the extraction of CO₂, the device in FIG. 5 serves to avoid the distribution pump.

1-4. (canceled)

5. A method for refrigerating one or more thermal loads whereby a first CO₂ source is provided from a mechanical refrigeration system, and in which one or more evaporators is fed from said first source to cause the evaporation of the CO₂ and thereby cool said one or more thermal loads,
wherein a second CO₂ source, consisting of a cryogenic CO₂ storage unit, is provided and in that there is an influx of CO₂ from said second source, so that the flow of fluid fed to the evaporator(s) is a mixture of liquid CO₂ issuing from said first source and liquid CO₂ issuing from said second source.

6. The refrigeration method of claim 5, wherein the mechanical refrigeration system carries out the steps of:
a) compression of CO₂ in the vapor state;
b) condensation of the CO₂ thus compressed in a heat exchanger;
c) expansion of the CO₂ thus subcooled;
d) storage of the CO₂ thus expanded in a storage tank;
and in that the following measures are carried out.
e) CO₂ is extracted from the storage tank to feed said one or more evaporators;
f) a quantity of CO₂ substantially equivalent to that corresponding to said influx of CO₂ is removed to the exterior by one or a combination of the following methods:
1) the fluid or part of the fluid obtained at the outlet of the evaporator(s) is sent to said storage tank and said CO₂ stream to be removed to the exterior is extracted and removed from said tank; and
2) part of the fluid obtained at the outlet of the evaporator(s) is separated and removed to the exterior, the remainder being sent either to said storage tank, or to said compression step; and
g) said influx of CO₂ from said second source is carried out in said storage tank where it is mixed with the CO₂ issuing from said evaporator(s) or from said expansion step.

7. The refrigeration method of claim 5, wherein a quantity of CO₂ substantially equivalent to that corresponding to said influx of CO₂ is removed to the exterior by one or a combination of the following methods.
a) the fluid or part of the fluid obtained at the outlet of the evaporator(s) is sent to a storage tank and said CO₂ stream to be removed to the exterior is extracted and removed from said tank;
b) part of the fluid obtained at the outlet of the evaporator(s) is separated and removed to the exterior, the remainder being sent either to said storage tank, or to a step of condensation by a cold source provided by a vapor compression system and the liquid thereby condensed is then stored in the storage tank;
and in that said influx of CO₂ from said second source is carried out in the storage tank where it is mixed with the CO₂ issuing from the evaporator(s) or from said condensation step.

8. The refrigeration method of claim 5, wherein the quantity of CO₂ present in the circuit is comprised between two predefined operating limits.
